(19) United States
(12) Patent Application Publication
(10) Pub. No.: US 2012/0118605 A1
(43) Pub. Date: May 17, 2012

(54) BUSBAR CLAMPING SYSTEMS

(75) Inventors: Matthew A. Williford, Nashville, TN (US); Olivier Bouffet, Brentwood, TN (US); Thomas W. Reed, JR., Seneca, SC (US)

(73) Assignee: Schneider Electric USA, Inc., Palatine, IL (US)

(21) Appl. No.: 12/947,949

(22) Filed: Nov. 17, 2010

(51) Int. Cl. H02G 5/00

(52) U.S. Cl. 174/68.2

(57) ABSTRACT

Busbar clamping systems and electric power busway systems for distributing electricity are disclosed herein. An aspect of this disclosure is directed to electrical busway systems with improved means for minimizing or eliminating gaps between the busbars, the surge clamps, and the duct housing. In one embodiment, the busway system includes a plurality of electrically conductive busbars. The busbars are stacked one on top of the other to create a busbar stack. The busway system also includes a first duct side in opposing spaced relation to a second duct side. The stack of busbars is disposed between the first and second duct sides. One or more cam fasteners operatively engage the stack top and/or stack bottom. The cam fasteners are configured to apply a selectively variable compressive force to the stack of busbars.

### FIELD OF THE INVENTION

The present invention relates generally to electrical distribution systems, and more particularly to structural housing supports for busway electrical distribution systems.

### BACKGROUND

Conventional busway power distribution systems supply electrical energy for commercial, residential, and industrial purposes. Busway systems are generally comprised of several factory-assembled sections, each of which includes a number of individually insulated, generally flat, elongated electrical conductors (“busbars”). The busbars are typically stacked one upon another and enclosed within a housing (“protective duct”), which is intended to provide protection and support for the busbars. In many designs, the housing includes a duct top and a duct bottom, which cover the flat surfaces of the busbars, and two or more duct sides of one or more panels each, which cover the lateral edges of the busbars. The duct tops and bottoms of the housing can be made of electrically conductive materials, such as aluminum or copper, for carrying the system ground current. The duct sides are generally made of a structurally robust material, such as steel, that is formed to provide strength to the housing. The housing is generally held together by rivets, screws, bolts, stitching, or other known methods.

During a short circuit, magnetic repulsion forces can be generated between the individual busbars, urging the busbars away from each other, which can cause the busbars to deform and, thus, the housing to bulge. In extreme cases, large short circuits can cause the housing to be pulled apart. To prevent or limit such damage, surge clamps are placed across the duct tops and bottoms at each end of the busway section and, often, at predetermined intervals along the longitudinal length of the busway section. The surge clamps are generally U-shaped in cross-section with flanges closing the ends. Existing surge clamps are bolted or otherwise rigidly to the sides of the housing. The surge clamps are designed to mitigate the external forces and vibrations caused by short-circuit stresses by supporting the busbars at intervals to thereby maintain the busbars in proper relationship to each other and to the enclosures of the busbars.

Most surge clamps are rigidly fastened to the duct sides, for example, by screws or bolts that pass through the duct side and into the surge clamp end flanges. In many current designs, the surge clamps merely act to retain the busbars within the duct housing, and do not apply a compressive force to the busbar stack. As such, due to inherent manufacturing variations and build tolerances caused during assembly of the clamps and busway section, one or more of the surge clamps may not properly contact the top/bottom of the housing leaving gaps therebetween. These inadvertent gaps between the top/bottom of the housing and the surge clamp allow the conductor bars to separate in a short circuit event and, in some cases, permanently deform and damage the housing. The deformation of the busbars through the gaps also create an impact load when the busbars finally contact the surge clamps, increasing the stress that the surge clamps must endure. In addition, inadvertent gaps between the various components of the busway create internal air pockets, which impair thermal dissipation of heat generated, for example, by the system's electrical resistivity. There is therefore a continuing need for surge clamp designs that more effectively maintain the busbars in proper relationship to each other and to the duct housing. There is also a continuing need for surge clamp designs that eliminate these unintentional gaps between the surge clamp and the housing.

### SUMMARY

Busbar clamping systems are disclosed herein that minimize or eliminate inadvertent gaps between the busbars, surge clamps, and the duct housing. In an exemplary configuration, the tolerances in the assembly can be diminished or removed by applying a cam-type interface between the surge clamp and the housing. For example, a cam fastener can be provided that moves the surge clamp into direct, solid contact with the top of the housing. In some instances, the cam fastener can apply a pre-load to the busway assembly, compressing the stacked busbars together. With the electrically conductive busbars secured in this manner, the short-circuit integrity resistance of the entire busway system is desirably increased.

Another benefit that can be realized from the disclosed concepts is to create a more thermally efficient busway system. Each layer of air that exists between the individual busbars or between the busbars and the housing provides a layer of thermal resistance that is detrimental to heat being dissipated from the busbars to the environment. Utilizing some of the teachings disclosed herein, the busway is compressed such that there are fewer and smaller intermittent layers of air and, thus, less thermal resistance in the system. By clamping the conductors together, the heat they produce can be more efficiently conducted out of the system. A more thermally efficient busway requires less conductor material, which translates to tremendous material cost savings.

According to some aspects of the present disclosure, an electrical busway system for distributing electricity is presented. The electrical busway system includes a plurality of electrically conductive busbars. The busbars are stacked one on top of the other to create a busbar stack with a top and bottom. The electrical busway system also includes a first duct side in opposing spaced relation to a second duct side. The stack of busbars are disposed between the first and second duct sides. A cam fastener operatively engages the stack top or the stack bottom. The cam fastener is configured to apply a selectively variable compressive force to the stack of busbars.

According to other aspects of the present disclosure, a busway system for distributing electricity is featured. The busway system includes a plurality of elongated, individually insulated, electrically conductive busbars. The busbars are stacked one on top of the other to define a busbar stack with a top and a bottom. The busway system also includes a first duct side in opposing spaced relation to a second duct side. The stack of busbars are disposed between and generally perpendicular with the first and second duct sides. A duct top is in opposing spaced relation to a duct bottom. The duct top is adjacent the stack top, whereas the duct bottom is adjacent the stack bottom. A plurality of cam fasteners is operatively attached to the first duct side, the second duct side, or both. The cam fasteners, which operatively engage the stack top or the stack bottom, are configured to apply a selectively variable compressive force to the stack of busbars.

According to other aspects of the present disclosure, an electrical busway system is presented. The busway system includes a plurality of electrically conductive busbars, which are stacked one on top of the other to define a busbar stack. The busway system also includes a first duct side in opposing spaced relation to a second duct side. The stacked busbars are disposed between the first and second duct sides. A plurality of threaded fasteners each pass through the first duct side, the second duct side, or both, and operatively engage the stack top or the stack bottom. The threaded fasteners are configured to apply a selectively variable compressive force to the stack of busbars.

The above summary is not intended to represent each embodiment or every aspect of the present disclosure. Rather, the foregoing summary merely provides an exemplification of some of the novel features included herein. The above features and advantages, and other features and advantages of the present disclosure, will be readily apparent from the following detailed description of the embodiments and best modes for carrying out the present invention when taken in connection with the accompanying drawings and appended claims.

### BRIEF DESCRIPTION OF THE DRAWINGS

FIG. 1 is an elevated perspective-view illustration of a section of an exemplary busway power distribution system in accordance with embodiments of the present disclosure.

FIG. 2 is an enlarged perspective-view illustration of a portion of the exemplary busway section of FIG. 1.

FIG. 3 is an enlarged perspective-view illustration of the exemplary busway power distribution section of FIG. 1 shown partially cut away along line 3-3 to more clearly depict an exemplary busbar clamping system in accordance with embodiments of the present disclosure.

FIG. 4 is another enlarged perspective-view illustration of the exemplary busway power distribution section of FIG. 1 shown partially cut away along line 4-4 to more clearly depict the exemplary busbar clamping system of FIG. 3.

FIG. 5 is an elevated perspective-view illustration of an exemplary side duct in accordance with embodiments of the present disclosure.

FIG. 6 is a perspective-view illustration of an exemplary latch plate in accordance with embodiments of the present disclosure.

FIG. 7 is a perspective-view illustration of an exemplary surge clamp in accordance with embodiments of the present disclosure.

FIG. 8 presents a perspective-view illustration and a front-view illustration of an exemplary cam nut in accordance with embodiments of the present disclosure.

FIGS. 9 and 10 are schematic illustrations of an exemplary busbar clamping system in accordance with other embodiments of the present disclosure.

FIGS. 11 and 12 are schematic illustrations of another exemplary busbar clamping system in accordance with embodiments of the present disclosure.

FIGS. 13 and 14 are schematic illustrations of yet another exemplary busbar clamping system in accordance with embodiments of the present disclosure.

FIGS. 15-17 are schematic illustrations of even yet another exemplary busbar clamping system in accordance with embodiments of the present disclosure.

While the present disclosure is susceptible to various modifications and alternative forms, specific embodiments have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of the invention as defined by the appended claims.

### DETAILED DESCRIPTION

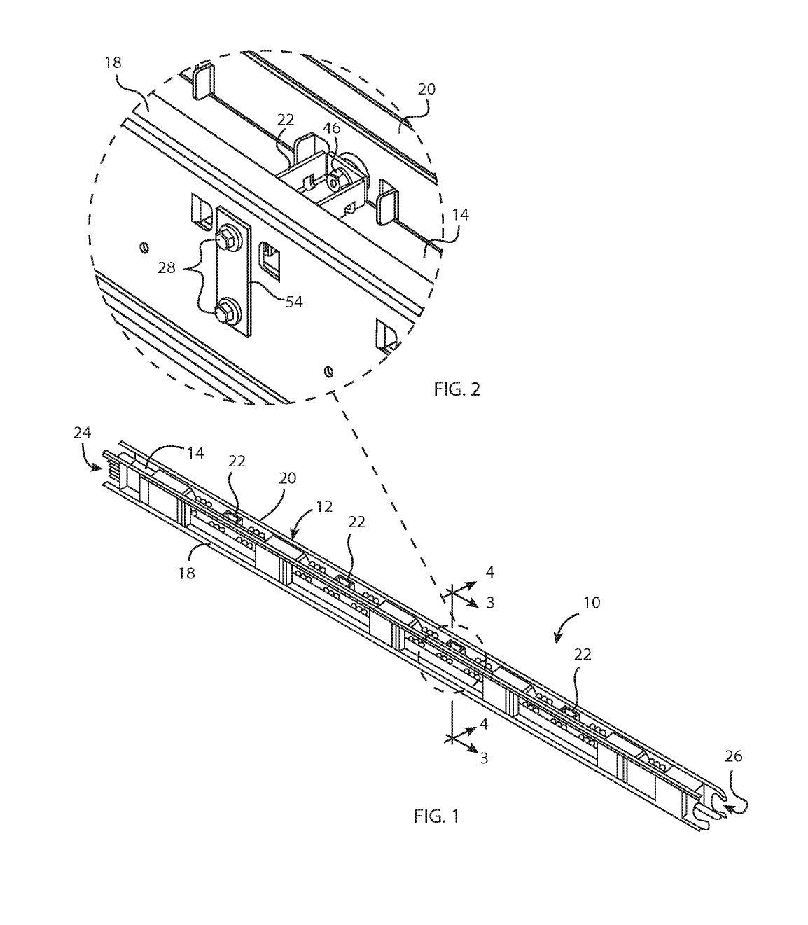

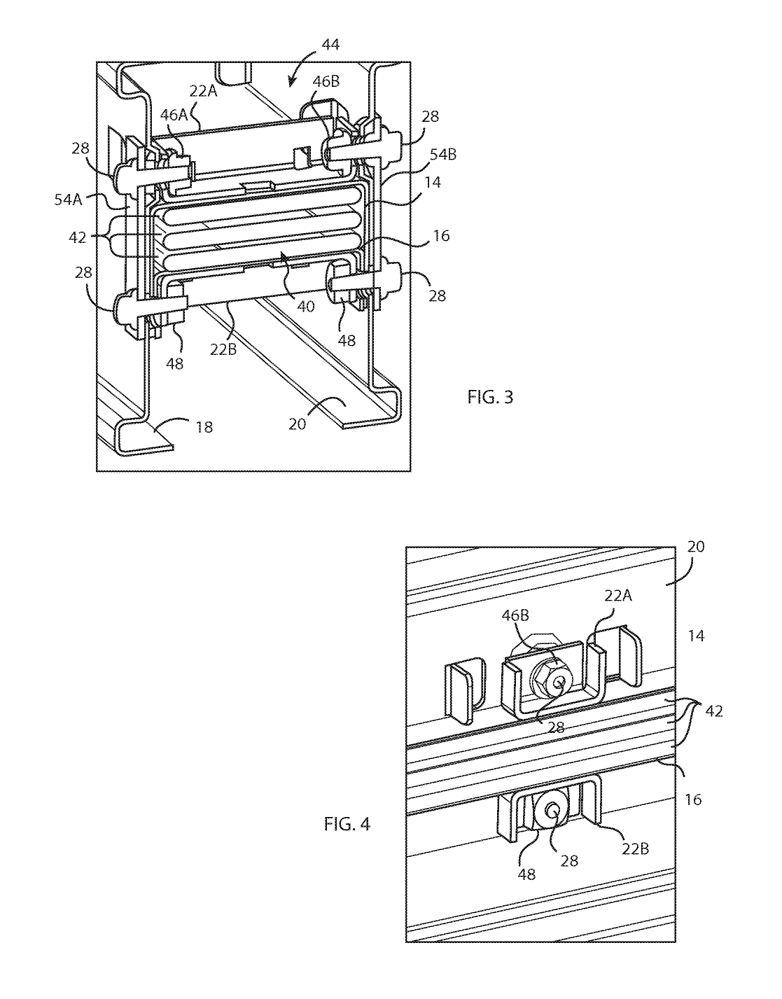

Referring now to the drawings, wherein like reference numerals refer to like components throughout the several views, FIG. 1 illustrates a section of an exemplary sectionalized busway electrical distribution system, designated generally as 10. The sections of a power busway cooperate to form an electric power distribution system for transporting electricity. The busway section 10 includes a housing, generally indicated by reference numeral 12. The housing 12 includes an elongated duct top 14, an elongated duct bottom 16 (best seen in FIG. 3), and two generally parallel, elongated duct sides 18 and 20, respectively, all of which extend along the longitudinal dimension of the busway section 10. In the embodiment of FIGS. 1-4, a number of generally U-shaped surge clamps 22 are placed laterally across the duct top 14 and duct bottom 16 at predetermined intervals along the longitudinal length of the busway section 10. At each end 24, 26 of the busway section 10, joint packs (not shown) will mechanically connect and electrically couple adjacent busway sections to the busway section 10.

Referring now to FIGS. 2-4 and 7, and more particularly to FIG. 3, a first set of surge clamps 22A is placed laterally across and abuts the duct top 14, positioned intermediate and generally perpendicular to the parallel duct sides 18, 20. A second set of surge clamps 22B is placed laterally across and abuts the duct bottom 16, positioned intermediate and generally perpendicular to the parallel duct sides 18, 20. In the illustrated embodiments, the surge clamps 22A and 22B are structurally similar, unless otherwise indicated, and therefore will be described collectively with reference to surge clamp 22 of FIG. 7. Each surge clamp 22 is formed from a rigid and robust material, such as 12 Ga. or 14 Ga. aluminum or steel. The surge clamp 22 is an oblong, channel-like structure having a generally flat bottom 30 with two generally parallel side walls 32 extending generally perpendicularly from the flat bottom 30 along the longitudinal dimension of the surge clamp 22. First and second end flanges 34A and 34B, respectively, extend generally perpendicularly from the flat bottom 30 at opposing longitudinal ends of the surge clamp 22. Each end flange 34A, 34B has a respective elongated slot 36A and 36B, each of which extends generally perpendicularly from the bottom 30 and is shaped and sized to receive a threaded fastener, such as bolts 28 of FIGS. 3-4, therethrough. The elongated slots 36A, 36B provide a means of attaching the surge clamp 22 to the duct sides 18, 20, as seen for example in FIG. 3, and allow the surge clamp 22 to translate or slide with respect to the first and second duct sides 18, 20. In some embodiments, only the first set of surge clamps 22A have elongated slots 36A, 36B, which operatively cooperate with the cam fastener 46A, 46B, whereas the second set of surge clamps 22B include standard, circular slots.

Enclosed within the housing 12 is a stack of busbars, which is designated 40 in FIG. 3. In the illustrated embodiment, the busbar stack 40 is sandwiched between the first and second surge clamps 22A, 22B. This exemplary busbar stack 40 is composed of a plurality of elongated, generally flat, individually insulated, electrically conductive busbars 42. For example, each busbars 42 can coated with an electrical insulator, such as epoxy or other non-conductive materials, and the stack 40 be protected by a plastic insulation protection sheet. The busbars 42 are laid flat one upon another, oriented between and generally perpendicular with the first and second duct sides 18, 20. Recognizably, the busbar stack 40 can be comprised of greater or fewer than three busbars 42. Moreover the individual construction of the busbars 42 can be modified, for example, to accommodate the intended application of the electrical distribution system.

With continuing reference to FIG. 3, the duct top 14 covers the flat top and lateral ends of the busbar stack 40, separating the busbar stack 40 from the first surge clamps 22A and the elongated duct sides 18 and 20. The duct bottom 16, which is interposed between the busbar stack 40 and the second surge clamps 22B, covers the flat bottom of the busbar stack 40. Both the duct top 14 and the duct bottom 16 have elongated, generally U-shaped bodies. In the embodiment of FIG. 3, the width and depth of the duct top 14 are sufficient to fit the busbar stack 40 and most of the duct bottom 16 between the lateral side walls of the U-shaped duct top 14. The width and the depth of the duct bottom 16 of FIG. 3, which are narrower and shallower, respectively, than that of the duct top 14, are sufficient to fit the surge clamp 22B between the lateral side walls of the U-shaped duct bottom 16. The duct top 14 and bottom 16 of the housing 12 can be made of electrically conductive materials, such as aluminum or copper, for carrying the system ground current.

FIG. 3 shows the exemplary busway power distribution section 10 partially cut away along line 3-3 of FIG. 1 to more clearly depict an exemplary busbar clamping system, designated generally as 44. In the embodiment illustrated in FIG. 3, the busbar clamping system 44 includes first and second cam fastener 46A and 46B, respectively. Each of the cam fastener 46A, 46B of FIG. 3 is a cam nut that threadably engages with the threaded shaft of a respective bolt 28. The cam fasteners 46A, 46B press against the inside surfaces of the surge clamp end flanges 34A, 34B, and cooperate with the bolts 28 to attach the first surge clamp 22A to the first and second duct sides 18, 20. In a similar regard, a pair of square nuts 48 threadably engage respective bolts 28 to attach the second surge clamp 22B to the first and second duct sides 18, 20. Each of the cam fasteners 46A, 46B operatively engages the top of the busbar stack 40, e.g., via surge clamp 22A. An alternative arrangement can include switching the cam fasteners 46A, 46B and square nuts 48 such that the cam fasteners 46A, 46B operatively engage the bottom of the busbar stack 40, e.g., via surge clamp 22B.

The cam fasteners 46A, 46B are configured to apply a selectively variable compressive force to the stack of busbars 40. By way of non-limiting example, each cam fastener 46A, 46B can be designed such that rotation of the fastener 46A, 46B about a respective bolt 28 acts to vary the force applied to the busbar stack 40 by that fastener 46A, 46B. One such design is illustrated in FIG. 8. Since the cam fasteners 46A, 46B of FIG. 3 are structurally identical, they will be described collectively with reference to cam nut 46 of FIG. 8. The cam nut 46 has a head 50 with a flange 52 projecting radially from the head 50. As shown, the head 50 of FIG. 8 has a polyhedral geometry such that the head 50 can be received within the hex head of a socket wrench for rotation of the cam nut 46. In contrast, the flange 52 of FIG. 8 is generally cylindrical with a circular cross-section. The shape and size of the head 50 and flange 52 can be varied, singly or collectively, without departing from the scope and spirit of the present invention. For instance, the flange 52 can have an oblong (e.g., elliptical) shape or an asymmetrical profile, such as a variable radius cam shape or a ratchet-tooth shape, as described below with respect to FIG. 10. Likewise, the head 50 can take on different forms, such as a circular cross-section with complementary channels for receiving a flat-head or a phillips (crosshead) screw driver. The shape of the flange 52 can be optimized to best compensate for the range of tolerance in a particular application. In addition, as will be described in further detail below, the cam fasteners 46A, 46B can be incorporated into a bolt or screw for alternate configurations.

With continuing reference to FIG. 8, the head 50 and flange 52 are non-concentric. In other words, the center Al of the head 50, which is also the axis about which the cam nut 46 rotates when turned on the bolt 28, is radially offset from the center A2 of the flange 52. Based on this configuration, rotation of the cam nut 46 about the bolt 28 will change the surface area of the flange 52 between the head center Al and the surge clamp 22A, and thus change the distance between the flat bottom 30 of the surge clamp 22A and the bolts 28 that attach the clamp 22A to the duct sides 18, 20. This, in turn, can compress the upper-most busbar 42 in the stack 40 against the remaining busbars 42 in the stack 40. By utilizing the illustrated design, the magnitude of the compressive force applied by the cam nut 46 to the busbar stack 40 can be selectively varied from a minimum compressive force, when the center A1 of the head 50 is closest to the surge clamp 22A, and a maximum compressive force, when the center A1 of the head 50 is furthest from the surge clamp 22A.

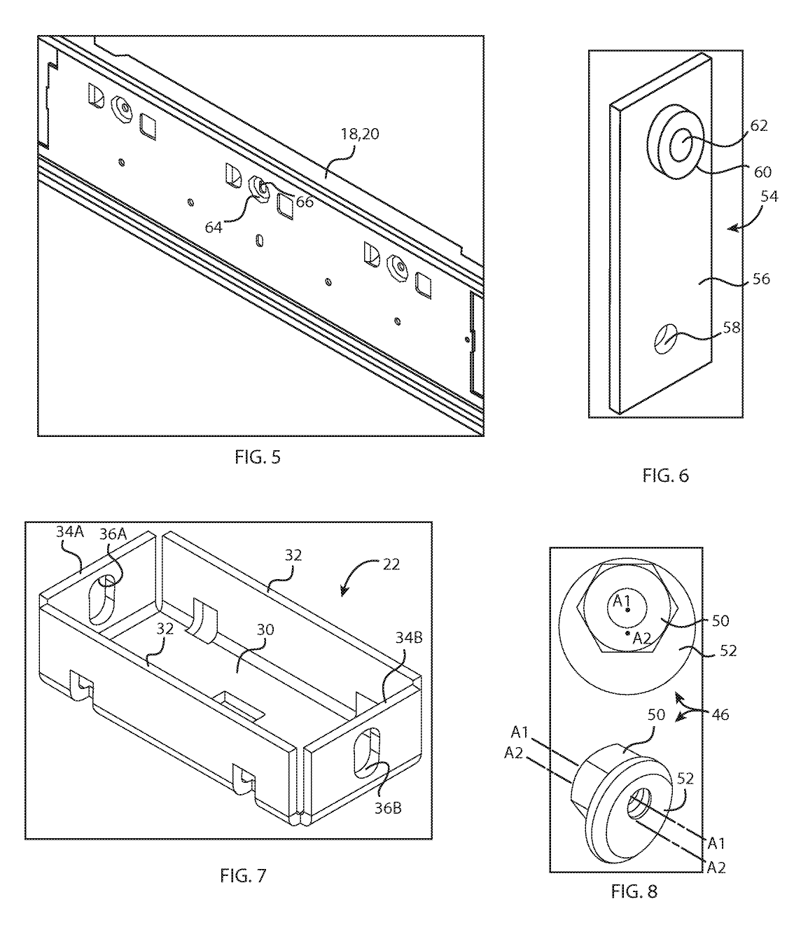

Turning to FIG. 6, a latch plate 54 is shown in accordance with embodiments of the present disclosure. The latch plate 54 of FIG. 6 has an elongated, generally flat and rectangular body 56 with a first hole 58 extending through a first end portion of the body 56. An embossed cylindrical protrusion 60, which has a second hole 62 extending therethrough, projects from a second end portion of the body 56, which is opposite the first end portion. The first and second holes 58, 62 in the latch plate 54 are designed to receive therethrough a threaded fastener, such as bolts 28 of FIG. 3. The busbar clamping system 44 illustrated in FIG. 3 is shown with two latch plates, namely first and second latch plates 54A and 54B, respectively, where the first latch plate 54A is disposed against an outside surface of the first duct side 18, and the second latch plate 54B is disposed against an outside surface of the second duct side 20. The first latch plate 54A connects the first cam fastener 46A to a corresponding one of the square nuts 48 via respective bolts 28 Likewise, the second latch plate 54B connects the second cam fastener 46B to another one of the square nuts 48 via respective bolts 28. As the cam fasteners 46A, 46B are rotated on their respective bolts 28, the respective cam surfaces of the fasteners 46A, 46B operate to urge the bolts 28, as described above, which in turn will cause the first and second latch plates MA, MB to translate relative to the first and second duct sides 18, 20. The first and second latch plates MA, MB act to draw the square nuts 48, and thus the second surge clamp 22B, toward the first and second cam fasteners 46A, 46B, and the first surge clamp 22A, such that the selectively variable compressive force generated by the cam fasteners 46A, 46B is applied to both the stack top and the stack bottom, which in turn more evenly distributes the compressive force throughout the busbar stack 40. The embossed protrusion 60 is optional, and can be eliminated from the latch plate body 56, for example, in embodiments where the ducts side 18, 20 do not include recessed pockets, which are discussed below.

As seen in FIG. 5, the first and second duct sides 18, 20 can be provided with recessed pockets 64, each of which is configured to receive the embossed protrusion 60 of a respective latch plate 54. By mating the embossed protrusion 60 with the recessed pocket 64, the latch plate 54 is operatively aligned with the surge clamp 22A. Each recessed pocket 64 has an elongated duct slot 66 through which the bolts 28 pass for operatively mounting the surge clamp 22A to the housing 12. The bolts 28 can translate rectilinearly within the elongated duct slots 66 such that the first and second cam fasteners 46A, 46B can slide with respect to the first and second duct sides 18, 20. The recessed pockets 64 and elongated duct slot 66 can be eliminated, for example, in embodiments that do not employ latch plates 54.

The busbar clamping system 44 provides improved short circuit protection, for example, by applying a desired clamping force to eliminate inadvertent gaps between the busway housing, the surge clamps, and the busbars, which in turn will also help compensate for manufacturing variations and build tolerances. This clamping force can increase busway short circuit strength by limiting or eliminating separation of the busbars during a short circuit event, which will reduce or possibly eliminate damage to the housing and busbars. Additionally, this solution would allow the busway to reach higher short circuit performance ratings. An additional benefit of these concepts is improved thermal performance of the busway system. By helping to compress all of the components in the busway together, thermally resistant air pockets that impede thermal efficiency of the busway are minimized or eliminated. With a more thermally efficient busway, the size of the busbars can be decreased, which allows for significant cost savings.

A representative method for assembling the busway section 10 includes, for example: (1) operatively aligning the second surge clamp 22B inside the duct bottom 16; (2) placing the busbar stack 40 on the upper surface of the duct bottom 16, on the opposite side of the second surge clamp 22B; (3) placing the duct top 14 over the busbar stack 40 in operative alignment with the second surge clamp 22B and the duct bottom 16; (4) loosely assembling the duct top and bottom 14, 16, second surge clamp 22B, and busbar stack 40 to the first and second duct sides 18, 20—e.g., by feeding standard bolts 28 through the holes 58 in the first and second latch plates 54A, 54B into threading engagement with standard nuts 48; (5) attaching the first surge clamp 22A and the first and second cam fasteners 46A, 46B to the duct sides 18, 20—e.g., by feeding standard bolts 28 through the holes 62 in the first and second latch plates 54A, 54B into threading engagement with the cam fasteners 46A, 46B, which are in a neutral position; (6) rotating the cam fasteners 46A, 46B, which draws the first and second surge clamps 22A, 22B together, until a predetermined compressive force is reached; and (7) tightening the bolts 28 on the second surge clamp 22B until tightly secured in position. Alternative methods of assembling the busway section 10 are also envisioned. For example, the order presented above can be varied without departing from the scope and spirit of the present disclosure.

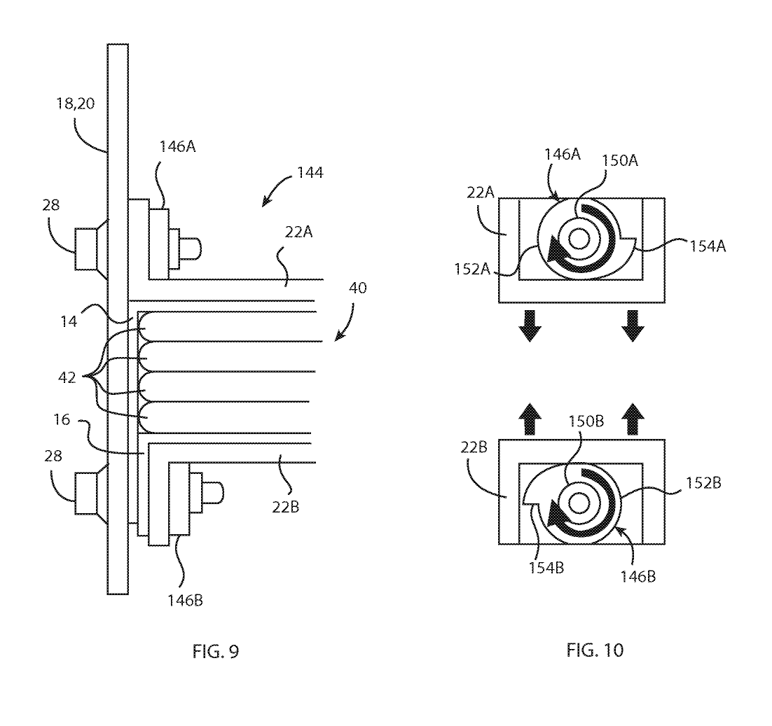

With reference next to FIGS. 9 and 10, wherein like reference numerals indicate similar components from FIGS. 1-8, a schematic illustration of another exemplary busbar clamping system, indicated generally at 144, is shown in accordance with other embodiments of the present disclosure. In contrast to the busbar clamping system 44 of FIG. 3, the busbar clamping system 144 of FIGS. 9 and 10 eliminates the need for the latch plate 54, and instead utilizes two sets of cam fasteners, one set on each side of the busbar stack 40. In particular, a first pair of cam fasteners 146A (only one cam fastener 146A being visible in FIGS. 9 and 10, but a second identical cam fastener being disposed on the opposite side of the busway section 10) cooperate with bolts 28 to attach the first surge clamp 22A to the first and second duct sides 18, 20, whereas a second pair of cam fasteners 146B (only one cam fastener 146B being visible in FIGS. 9 and 10, but a second identical cam fastener being disposed on the opposite side of the busway section 10) cooperate with the bolts 28 to attach the second surge clamp 22B to the first and second duct sides 18, 20. In this case, the first and second pairs of cam fasteners 146A, 146B are not latched together by a pair of latch plates 54A, 54B, as seen in the embodiment of FIG. 3. In some embodiments, each cam fastener 146A, 146B is a sheet metal part with a non-threaded extrusion for receiving a self tapping screw.

The first and second pairs of cam fasteners 146A, 146B are configured to apply a selectively variable compressive force to the stack of busbars 40. By way of non-limiting example, each cam fastener 146A, 146B can be designed such that rotation of the fastener 146A, 146B about a respective bolt 28 acts to vary the force applied to the busbar stack 40 by that fastener 146A, 146B. In the illustrated embodiment, each cam fastener 146A, 146B has a head 150A and 150B, respectively, with a flange 152A and 152B, respectively, projecting radially from the head 150A, 150B. Each flange 152A, 152B is shown in FIG. 10 as having a ratchet-tooth shape with a corresponding ratchet tooth 154A and 154B, respectively. The ratchet-tooth shape of the flanges 152A, 152B provides a differential cam surface whereby rotation of the cam fasteners 146A, 146B about a bolt 28 will change the distance between the heads 150A, 150B and the surge clamp 22A, and thus will change the distance between the flat bottom 30 of the surge clamp 22A and the bolts 28 that attach the clamp 22A to the duct sides 18, 20. This, in turn, will compress the upper-most and lower-most busbars 42 in the stack 40 against the remaining busbars 42 in the stack 40. The cam fasteners 146A, 146B can be separately torqued to individually compensate for tolerances on both sides of the housing 10 and provide a selectively variable clamping force. In some embodiments, the ratchet-tooth shaped flanges 152A, 152B can be configured to lock into a respective duct side 18, 20. In this instance, the cam fasteners 146A, 146B cannot rotate backwards (e.g., counterclockwise in FIG. 10) since the cam fastener 146A, 146B is locked in a vertical position if fully engaged by the threads of the bolts 28. The flange on the bolt 28 could also be teethed to prevent backwards rotation. The shape of the flange 152A, 152B can be optimized to best compensate for the range of tolerance in a particular application. In addition, the cam fasteners 146A, 146B can be incorporated into a bolt or screw for alternate configurations.

A representative method for assembling the busway section 10 illustrated in FIG. 9 includes, for example: (1) operatively aligning the second surge clamp 22B inside the duct bottom 16; (2) placing the busbar stack 40 on the upper surface of the duct bottom 16, on the opposite side of the second surge clamp 22B; (3) placing the duct top 14 over the busbar stack 40 in operative alignment with the second surge clamp 22B and the duct bottom 16; (4) loosely assembling the duct top and bottom 14, 16, second surge clamp 22B, and busbar stack 40 to the first and second duct sides 18, 20—e.g., by feeding bolts 28 through the ducts sides 18, 20 into threading engagement with the cam fasteners 146B, which are placed in a neutral position; (5) attaching the first surge clamp 22A to the duct sides 18, 20—e.g., by feeding bolts 28 through the ducts sides 18, 20 into threading engagement with the cam fasteners 146A, which are placed in a neutral position; and (6) rotating the first and second sets of cam fasteners 146A, 146B, which acts to draw the first and second surge clamps 22A, 22B together, until a predetermined compressive force(s) is reached. Alternative methods of assembling the busway section 10 illustrated in FIG. 9 are also envisioned. For example, the order presented above can be varied without departing from the scope and spirit of the present disclosure.

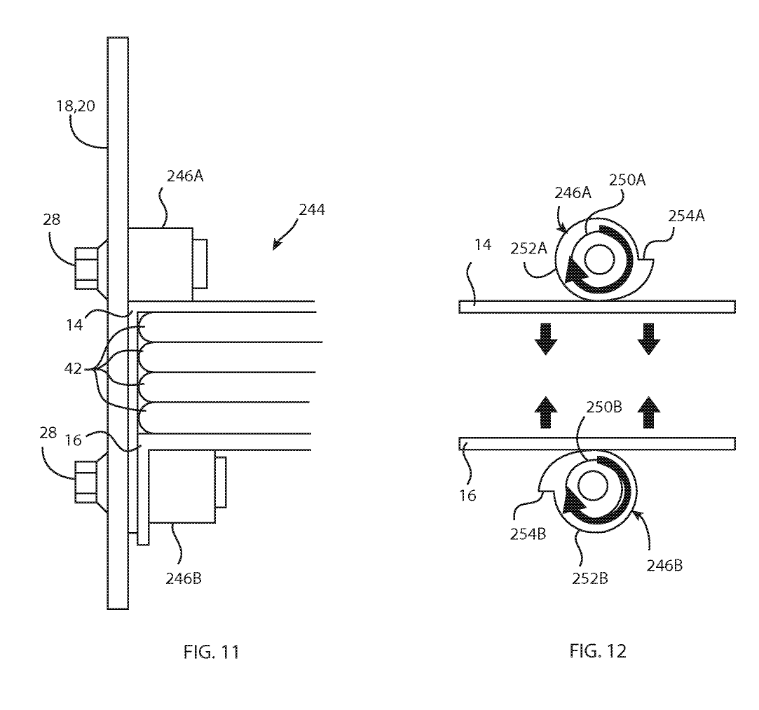

With reference next to FIGS. 11 and 12, wherein like reference numerals indicate similar components from FIGS. 1-10, a schematic illustration of another exemplary busbar clamping system, indicated generally at 244, is shown in accordance with other embodiments of the present disclosure. In contrast to the busbar clamping system 44 of FIG. 3, the busbar clamping system 244 of FIGS. 11 and 12 eliminates the need for the latch plates 54, and instead utilizes two sets of cam fasteners, one set on each side of the busbar stack 40. In addition, the busbar clamping system 244 of FIGS. 11 and 12 eliminates the need for the first and second surge clamps 22A, 22B. In particular, a first pair of elongated cam fasteners 246A (only one cam fastener 246A being visible in FIGS. 11 and 12, but a second identical cam fastener being disposed on the opposite side of the busway section 10) cooperate with bolts 28 to attach to the first and second duct sides 18, 20, whereas a second pair of elongated cam fasteners 246B (only one cam fastener 146B being visible in FIGS. 11 and 12, but a second identical cam fastener being disposed on the opposite side of the busway section 10) cooperate with the bolts 28 to attach to the first and second duct sides 18, 20. In this case, the first and second pairs of cam fasteners 146A, 146B are not latched together by a pair of latch plates 54A, 54B. Moreover, the first pair of elongated cam fasteners 246A directly contact the duct top 14, whereas the second pair of elongated cam fasteners 246B directly contact the duct bottom 16. The additional size of the elongated cam fasteners 246A, 246B in FIGS. 11 and 12, as compared to the cam fasteners in FIGS. 1-10, provides sufficient support and clamping strength for the duct top and bottom 14, 16 and the busbars 42, thereby eliminating the need for surge clamps 22A, 22B.

The first and second pairs of elongated cam fasteners 246A, 246B are configured to apply a selectively variable compressive force to the stack of busbars 40. By way of non-limiting example, each cam fastener 246A, 246B can be designed such that rotation of the fastener 246A, 246B about a respective bolt 28 acts to vary the force applied to the busbar stack 40 by that fastener 246A, 246B. In the illustrated embodiment, each cam fastener 246A, 246B has a head 250A and 250B protruding from an elongated body 252A and 252B, respectively. Each elongated body 252A, 252B is shown in FIG. 10 as having a ratchet-tooth shape with a corresponding ratchet tooth 254A and 254B, respectively. The ratchet-tooth shape of the elongated bodies 252A, 252B provides a differential cam surface whereby rotation of the cam fasteners 246A about respective bolts 28 will change the distance between the head 250A and the duct top 14, and rotation of the cam fasteners 246B about respective bolts 28 will change the distance between the head 250B and the duct bottom 16. This, in turn, will compress the upper-most and lower-most busbars 42 in the stack 40 against the remaining busbars 42 in the stack 40. The cam fasteners 246A, 246B can be separately torqued to individually compensate for tolerances on both sides of the housing 10 and provide a selectively variable clamping force. In some embodiments, the ratchet-tooth shaped bodies 252A, 252B can be configured to lock into a respective duct side 18, 20, similar to the ratchet-tooth shaped flanges 152A, 152B of FIG. 10. The shape of the bodies 252A, 252B can be optimized to best compensate for the range of tolerance in a particular application. In addition, the cam fasteners 246A, 246B can be incorporated into a bolt or screw for alternate configurations.

A representative method for assembling the busway section 10 illustrated in FIG. 11 includes, for example: (1) placing the busbar stack 40 on the upper surface of the duct bottom 16; (2) placing the duct top 14 over the busbar stack 40 in operative alignment with the duct bottom 16; (3) loosely assembling the duct top and bottom 14, 16 and busbar stack 40 to the first and second duct sides 18, 20—e.g., by feeding bolts 28 through the ducts sides 18, 20 into threading engagement with the cam fasteners 246B, which are placed in a neutral position; (4) feeding bolts 28 through the ducts sides 18, 20 into threading engagement with the cam fasteners 246A, which are placed in a neutral position; and (5) rotating the first and second sets of cam fasteners 246A, 246B, which acts to draw the duct top 18 and duct bottom 20 together, until a predetermined compressive force(s) is reached. Alternative methods of assembling the busway section 10 illustrated in FIG. 11 are also envisioned. For example, the order presented above can be varied without departing from the scope and spirit of the present disclosure.

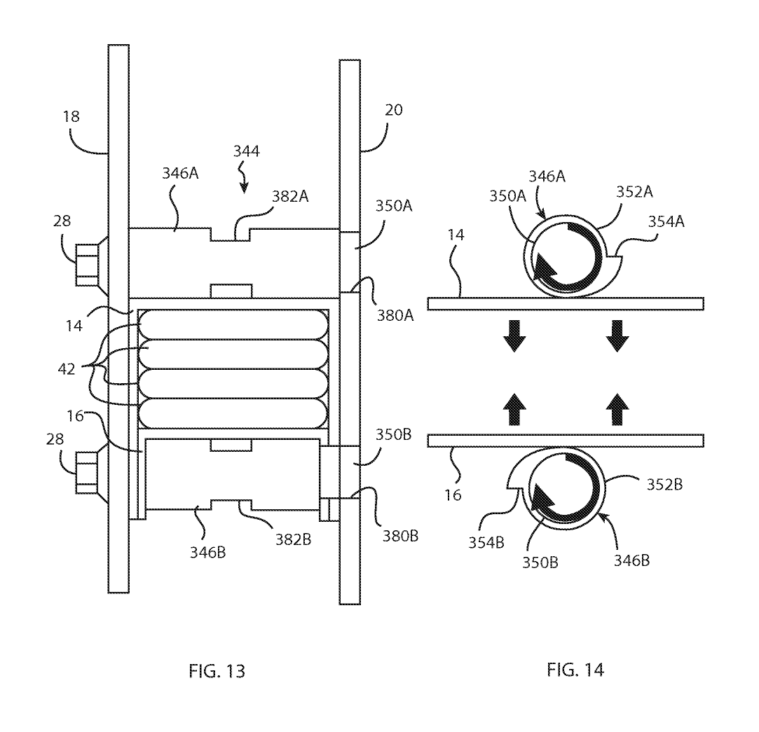

With reference next to FIGS. 13 and 14, wherein like reference numerals indicate similar components from FIGS. 1-12, a schematic illustration of another exemplary busbar clamping system, indicated generally at 344, is shown in accordance with other embodiments of the present disclosure. In contrast to the busbar clamping system 44 of FIG. 3, the busbar clamping system 344 of FIGS. 13 and 14 eliminates the need for the latch plates 54, and instead utilizes two sets of cam fasteners, one set on each side of the busbar stack 40. In addition, the busbar clamping system 344 of FIGS. 13 and 14 eliminates the need for the first and second surge clamps 22A, 22B. In particular, a first elongated cam fastener 346A spans the width of the housing 10, cooperating with a bolt 28 to attach to the first duct side 18 and inserted at a distal end into a corresponding receiving aperture 380A in the second duct side 20. A second elongated cam fastener 346B spans the width of the housing 10, cooperating with a bolt 28 to attach to the first duct side 18 and inserted at a distal end into a corresponding receiving aperture 380B in the second duct side 20. In this case, the first and second elongated cam fasteners 346A, 346B are not latched together by a pair of latch plates 54A, 54B. Moreover, the first elongated cam fastener 346A directly contacts the duct top 14, whereas the second elongated cam fastener 346B directly contacts the duct bottom 16. Because the elongated cam fasteners 346A, 346B in FIGS. 13 and 14 extend the distance between the first and second duct sides 18, 20, they can be configured to provide sufficient support and clamping strength for the duct top and bottom 14, 16 and the busbars 42, thereby eliminating the need for surge clamps 22A, 22B.

The first and second elongated cam fasteners 346A, 346B are configured to apply a selectively variable compressive force to the stack of busbars 40. By way of non-limiting example, each elongated cam fastener 346A, 346B can be designed such that rotation of the cam fastener 346A, 346B about its respective longitudinal axis acts to vary the force applied to the busbar stack 40 by that cam fastener 346A, 346B. In the illustrated embodiment, each cam fastener 346A, 346B has a head 350A and 350B protruding from an elongated body 352A and 352B, respectively. Each elongated body 352A, 352B is shown in FIG. 14 as having a ratchet-tooth shape with a corresponding ratchet tooth 354A and 354B, respectively. The ratchet-tooth shape of the elongated bodies 352A, 352B provides a differential cam surface whereby rotation of the cam fastener 346A about its longitudinal axis (e.g., via a wrench being applied to hex flats 382A) will change the distance between the head 350A and the duct top 14, and rotation of the cam fastener 346B about its longitudinal axis (e.g., via a wrench being applied to hex flats 382B) will change the distance between the head 350B and the duct bottom 16. This, in turn, will compress the upper-most and lower-most busbars 42 in the stack 40 against the remaining busbars 42 in the stack 40. The cam fasteners 346A, 346B of FIGS. 13 and 14 can be separately torqued to individually compensate for tolerances on both sides of the housing 10 and provide a selectively variable clamping force. In some embodiments, the ratchet-tooth shaped bodies 352A, 352B can be configured to lock into a respective duct side 18, 20, similar to the ratchet-tooth shaped flanges 152A, 152B of FIG. 10. The shape of the bodies 352A, 352B of the cam fasteners 346A, 346B illustrated in FIGS. 13 and 14 can be optimized to best compensate for the range of tolerance in a particular application. In addition, the cam fasteners 246A, 246B can be incorporated into a bolt or screw for alternate configurations.

It should be recognized that the general configuration of the cam fastener 46 illustrated in FIG. 8 can be applied in the embodiments of FIGS. 9-14 (and vice versa).

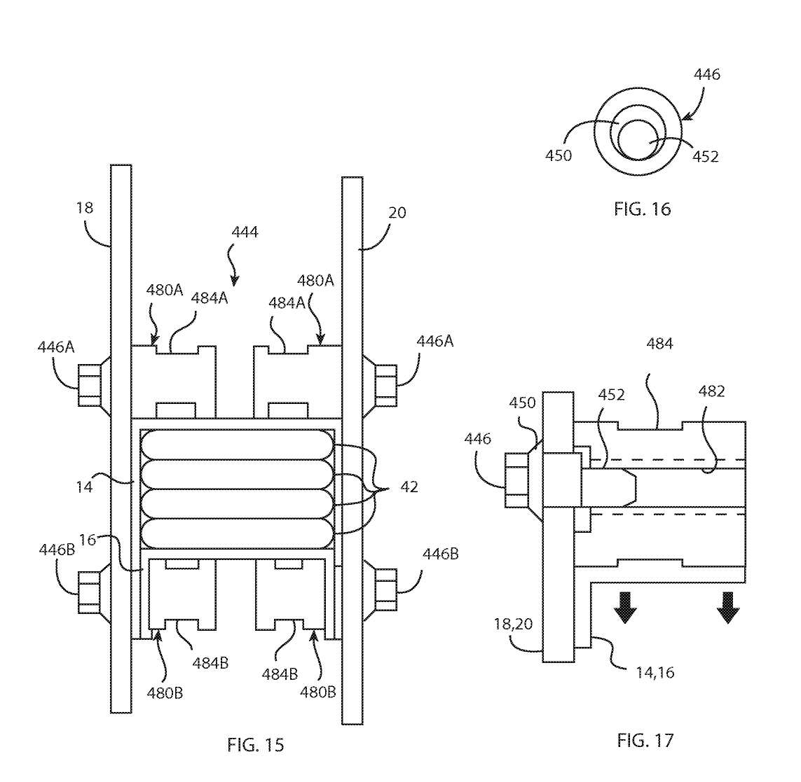

With reference next to FIGS. 15-17, wherein like reference numerals indicate similar components from FIGS. 1-14, a schematic illustration of another exemplary busbar clamping system, indicated generally at 444, is shown in accordance with other embodiments of the present disclosure. In contrast to the busbar clamping system 44 of FIG. 3, the busbar clamping system 444 of FIGS. 15-17 eliminates the need for the latch plates 54, and instead utilizes two sets of cam fasteners, one set on each side of the busbar stack 40. In addition, the busbar clamping system 444 eliminates the need for the first and second surge clamps 22A, 22B. In particular, a first pair of cam fasteners 446A, which in this embodiment are cam bolts best seen in FIGS. 16 and 17, cooperate with elongated rods 480A to attach to the first and second duct sides 18, 20. A second pair of cam fasteners 446B, which in this embodiment are also cam bolts that are best seen in FIGS. 16 and 17, cooperate with elongated rods 480B to attach to the first and second duct sides 18, 20. In the illustrated embodiments, the cam fasteners 446A, 446B are structurally identical, and therefore will be described collectively with reference to cam bolt 446 of FIGS. 16 and 17. Likewise, the elongated rods 480A, 480B are structurally identical, and therefore will be described collectively with reference to the elongated rods 480 in FIG. 17.

This embodiment demonstrates how the cam feature can be incorporated into a bolt configuration rather than the nut configuration. In this case, the first and second pairs of cam fasteners 446A, 446B are not latched together by a pair of latch plates 54A, 54B. Moreover, the first pair of elongated cam fasteners 446A directly contact the duct top 14, whereas the second pair of elongated cam fasteners 446B directly contact the duct bottom 16. The additional size of the elongated rods 480A, 480B, provides sufficient support and clamping strength for the duct top and bottom 14, 16 and the busbars 42, thereby eliminating the need for surge clamps 22A, 22B. Recognizably, surge clamps could still be used for further improvement of the Short Circuit Current Rating.

The first and second pairs of cam fasteners 446A, 446B are configured to apply a selectively variable compressive force to the stack of busbars 40. By way of non-limiting example, each cam fastener 446A, 446B can be designed such that rotation of the fastener 446A, 446B acts to vary the force applied to the busbar stack 40 by a corresponding rod 480A, 480B. In the illustrated embodiment, the cam bolt 446 has a head 450 with a threaded shaft 452 protruding from the head 450. The threaded shaft 452 is received in a threaded channel 482 in the elongated rod 480, as seen in FIG. 17. Alternatively, the cam bolt 446 can be self-threading. In some embodiments, the elongated rod 480 must be threaded onto the cam bolt 446. The head 450 and the shaft 452 are non-concentric, with the center of the head 450, which is also the axis about which the cam bolt 446 rotates, is radially offset form the center of the flange shaft 452. As such, rotation of the cam bolt 446 will operate to shift the location of the elongated rod 480 relative to the duct side 18, 20, which will change the distance between the head 450 and the duct top/bottom 14, 16. This, in turn, will compress the upper-most/lower-most busbar 42 in the stack 40 against the remaining busbars 42 in the stack 40. The elongated rods 480A, 480B can be separately torqued—e.g., via a wrench being applied to hex flats 484A, 484B. In addition, the cam bolts 446A, 446B can be separately torqued to individually compensate for tolerances on both sides of the housing 10 and provide a selectively variable clamping force. In some applications, the cam bolt 446 cannot be turned until ready to engage the cam force—i.e., once the elongated rod 480 is fully threaded onto the cam bolts 446A, the cam bolts 446A can be rotated (e.g., 180 degrees) to apply the necessary clamping force.

While particular embodiments and applications of the present invention have been illustrated and described, it is to be understood that the invention is not limited to the precise construction and compositions disclosed herein and that various modifications, changes, and variations can be apparent from the foregoing descriptions without departing from the spirit and scope of the invention as defined in the appended claims. To that extent, elements and limitations that are disclosed, for example, in the Abstract, Summary, and Detailed Description sections, but not explicitly set forth in the claims, should not be incorporated into the claims, singly or collectively, by implication, inference or otherwise.

What is claimed is:

1. An electrical busway system for distributing electricity, the electrical busway system comprising:
a plurality of electrically conductive busbars, the busbars being stacked one on top of the other to define a stack top and a stack bottom;
a first duct side;
a second duct side in opposing spaced relation to the first duct side, the stack of busbars being disposed between the first and second duct sides; and
a first cam fastener operatively engaging the stack top or the stack bottom, the first cam fastener being configured to apply a selectively variable compressive force to the stack of busbars.

2. The electrical busway system of claim 1, wherein the first cam fastener has a head with a flange projecting outward therefrom, the head and the flange being non-concentric.

3. The electrical busway system of claim 2, wherein the head is polyhedral and the flange is circular.

4. The electrical busway system of claim 1, wherein the first cam fastener has a head with a flange projecting outward therefrom, the flange having an oblong or asymmetrical profile.

5. The electrical busway system of claim 4, wherein the head is polyhedral and the flange includes a ratchet tooth.

6. The electrical busway system of claim 1, further comprising a first surge clamp engaging the stack top or the stack bottom, the first surge clamp including first and second end flanges, the first end flange, the second end flange, or both defining a respective elongated slot configured to allow the first surge clamp to slide with respect to the first and second duct sides.

7. The electrical busway system of claim 6, further comprising a second surge clamp engaging the other of the stack top and the stack bottom, the second surge clamp being configured to rigidly attach to the first and second duct sides such that the stack of busbars is sandwiched between the first and second surge clamps.

8. The electrical busway system of claim 1, further comprising:
a fastener engaging one of the stack top and the stack bottom not being engaged by the first cam fastener; and
a latch plate connecting the first cam fastener to the fastener, the latch plate being configured to draw the fastener toward the first cam fastener such that the selectively variable compressive force is applied to both the stack top and the stack bottom.

9. The electrical busway system of claim 1, wherein the first cam fastener engages the first duct side, the busway system further comprising a second cam fastener engaging the second duct side and operatively engaging the stack top or the stack bottom operatively engaged by the first cam fastener, the second cam fastener cooperating with the first cam fastener to apply the selectively variable compressive force to the stack of busbars.

10. The electrical busway system of claim 9, wherein the first cam fastener includes a first elongated body and the second cam fastener includes a second elongated body.

11. The electrical busway system of claim 9, wherein the first cam fastener is generally concentrically aligned with the second cam fastener.

12. The electrical busway system of claim 1, further comprising a second cam fastener operatively engaging one of the stack top and the stack bottom not being engaged by the first cam fastener, the second cam fastener being configured to apply a second selectively variable compressive force to the stack of busbars.

13. The electrical busway system of claim 1, wherein the first cam fastener includes an elongated body extending from the first duct side to the second duct side.

14. The electrical busway system of claim 13, wherein the elongated body includes a plurality of hex flats configured to aid in rotating the first cam fastener.

15. The electrical busway system of claim 1, wherein the cam fastener is one of a cam nut, a cam bolt, and a cam screw.

16. The electrical busway system of claim 1, wherein the first cam fastener passes through the first duct side, the second duct side, or both.

17. The electrical busway system of claim 1, further comprising:
a duct top adjacent the stack top; and
a duct bottom in opposing spaced relation to the duct top, the duct bottom being adjacent the stack bottom.

18. A busway system for distributing electricity, the busway system comprising:
a plurality of elongated, individually insulated, electrically conductive busbars, the busbars being stacked one on top of the other to define a stack top and a stack bottom;
a first duct side in opposing spaced relation to a second duct side, the stack of busbars being disposed between and generally perpendicular with the first and second duct sides;
a duct top adjacent the stack top;
a duct bottom in opposing spaced relation to the duct top, the duct bottom being adjacent the stack bottom; and
a plurality of cam fasteners operatively attached to the first duct side, the second duct side, or both, and operatively engaging the stack top or the stack bottom, the plurality of cam fasteners being configured to apply a selectively variable compressive force to the stack of busbars.

19. An electrical busway system for distributing electricity, the electrical busway system comprising:
a plurality of electrically conductive busbars, the plurality of busbars being stacked one on top of the other to define a stack top and a stack bottom;
a first duct side;
a second duct side in opposing spaced relation to the first duct side, the stack of busbars being disposed between the first and second duct sides; and
a plurality of threaded fasteners each passing through the first duct side, the second duct side, or both, and operatively engaging the stack top or the stack bottom, the plurality of threaded fasteners being configured to apply a selectively variable compressive force to the stack of busbars.
